(19) United States
(12) Patent Application Publication
(10) Pub. No.: US 2024/0065923 A1
(43) Pub. Date: Feb. 29, 2024

(54) MASSAGE APPARATUS

(71) Applicant: Hwan Kyung OH, Yongin-si (KR)

(72) Inventor: Hwan Kyung OH, Yongin-si (KR)

(21) Appl. No.: 17/895,277

(22) Filed: Aug. 25, 2022

(51) Int. Cl. A61H 7/00

(52) U.S. Cl. CPC A61H 7/002; A61H 2201/0119; A61H 2201/1253; A61H 2201/1628; A61H 2205/04; A61H 2205/088; A61H 2205/108

(57) ABSTRACT

A massage apparatus of the disclosure includes a base part configured to be supported by the floor and protruding upwards, a pair of main protrusions protruding upwards from respective side portions of the base part, a plurality of sub-protrusions formed between the pair of main protrusions so as to be lower and smaller than the pair of main protrusions, and a lower rounded part formed on the lower surface of the base part so as to be rounded downwards and to take the form of a convex curved surface.

### BACKGROUND OF THE INVENTION

### Field of the Invention

The present invention relates to a massage apparatus, and more particularly to a massage apparatus capable of massaging the iliopsoas muscles, the waist muscles, or the thigh muscles of the human body and capable of massaging the muscles between the occipital bone and the cervical vertebrae or the muscles between the cervical vertebrae and the thoracic vertebrae.

### Description of the Related Art

Due to lack of exercise, and as more and more people work in the same position for a long time, one of the diseases that frequently occur is backache due to disc, shoulder pain due to excessive movement of shoulders and arms, and muscle pain, etc. Especially in the case of officer workers or students who sit for a long time, the number of cases of suffering from spinal diseases is rapidly increasing.

In the meanwhile, the spine consists of the vertebral body that is the central body, the bow-shaped vertebral arch protruding from the vertebral body towards the upper rear, and several projections, etc. and a large vertebral foramen is formed in the center, surrounded by the vertebral body and the vertebral arch. Such spine develops spinal diseases due to maintaining a poor posture for a long time, or muscle aging and strong external shock, etc. Most spinal diseases can be attributed to excessive force applied to the spine abnormally, that is, the cause thereof can be found in the lifestyle habits such as the usual sitting, standing, or sleeping posture. In the case of children and adolescents who are undergoing growth, if there is an abnormality in the spine, the growth line is under pressure and the secretion of growth hormone is not smooth, which leads to the problem of inhibiting growth.

In particular, in recent years, as the use time of smartphones increases regardless of gender and age, more and more people are suffering from diseases of the cervical vertebrae, which is the part between the skull and the thoracic vertebrae that is a part of the backbone, among the parts that make up the spine.

In other words, the cervical vertebrae are generally referred to as the neck bones among the vertebrae of our body and consist of seven vertebral segments. The transverse process of each cervical vertebra has a hole through which the cervical artery passes, and veins and the brachial plexus are located therearound. The cervical vertebrae can be said to be an important part of the body that is connected to the torso below and connected to the head above. Like the thoracic vertebrae and lumbar vertebrae, such cervical vertebrae are heavily affected by human posture and have various musculoskeletal disorders caused thereby. As an example, as with other vertebral discs, cervical disc herniation may occur, sprain occurs in the ligament supporting the cervical vertebrae from the back, and the cervical vertebrae muscles are also stiff due to various causes and compress nerves, resulting in various musculoskeletal disorders such as headache, neck pain, shoulder pain, etc.

In the meanwhile, the suboccipital muscles are parts located between the cervical vertebrae and the occipital bone and consist of a total of eight muscles in both sides, four muscles in each side. The suboccipital muscles have the greatest influence on stabilization of the head. As representative muscles of headache, the suboccipital muscles are closely related to brain and blood pressure disorders because many muscle spindles are distributed, and they are adjacent to the vertebral artery. The suboccipital muscles connect the occipital bone to the first and second cervical vertebrae and are closely related thereto. If stenosis occurs in the suboccipital triangle surrounding the vertebral artery among the suboccipital muscles, the nerve is compressed, blood supply to the brain is disturbed, and the function of the muscle spindle may be declined. In addition, stiffness of the suboccipital muscles may cause cervical vertebral headaches in which the pain extends forward from the occipital bone to the eye and forehead in one direction. Among the suboccipital muscle group, the rectus capitis posterior minor is an important muscle structure that holds the spinal cord so that the spinal cord is located in the center. The dura mater and the fascia of the rectus capitis posterior minor are connected to each other by connective tissue, and if tension is present in this structure, mechanical tension is created in the denticulate ligament, which may cause deformation of the dura mater surrounding the spinal nerve.

In general, for the treatment of back pain or shoulder pain, methods for treating or alleviating pathological conditions are widely practiced, such as physical therapy that strengthens muscles or stimulates acupuncture points to facilitate blood circulation. In addition, in the case of spinal diseases, it is desirable to correct the body shape by relaxing the intervertebral discs that are pressed by widening the gap between the vertebral bodies.

In other words, acupressure or massage is a kind of manual procedure that corrects the body's alterations to cure diseases and promote health by applying mechanical stimulation directly to the skin in a certain way using hands, causing a biological reaction. Acupressure and massage promote circulation of blood or lymph, boost metabolism to improve health of tissue, excrete waste, and enhance resistance. Since this tactile stimulus stimulates nerves and acts as an analgesic, it has the effect of promoting the recovery of paralyzed nerves and correcting the alteration of internal function.

However, since most of these acupressure and massage cannot be performed by the person receiving treatment alone, there is an inconvenience of having help from others, and there is a problem in that the effect is not consistent because it is performed depending on human power. In order to overcome such problems, various types of acupressure and massage apparatuses by which people can receive acupressure and massage by themselves have been conventionally developed and used. Vibration massagers that vibrate the acupressure tool using a driving source and air pressure massagers using air pressure are mainstream. However, because the vibration massager repeatedly strikes (taps) a part of the body, it has the disadvantage of not only having low acupressure effect but also causing secondary pain due to the striking. In addition, in order to properly transmit the vibration of the acupressure tool to the body, it is necessary to press the acupressure tool with a certain force, so there is a problem in that it is not only inconvenient to use, but it is also difficult to use continuously because it is hard to use.

In addition, in the case of an air pressure massager, pressure is repeatedly applied to a part of the body by injecting and discharging air into and out of a cuff designed to wrap a body part such as an arm, leg, or waist. Because the air pressure massager simply rubs a part of the body, it is difficult to achieve acupressure effects such as stimulating acupuncture points, and it has the disadvantage of inconvenient use because it should be worn on the arms, legs, or waist of the body. Although, among these air pressure massagers, there is a treatment device equipped with a belt-shaped cuff that expands up and down by the action of air pressure to act as a traction force, this is also inconvenient to use because it should be worn on the neck or waist, and it is difficult to respond quickly when excessive air pressure is applied, and it has the disadvantage of low treatment effect because sufficient traction effect cannot be obtained.

In addition, the conventional massager has a problem in that it cannot massage various body parts because it can mainly massage one or two parts, such as the cervical spine or waist muscles.

### SUMMARY OF THE INVENTION

It is an object of the present invention to provide a massage apparatus capable of massaging the iliopsoas muscles, the waist muscles, or the thigh muscles located deep inside the human body and capable of massaging the muscles between the occipital bone and the cervical vertebrae or the muscles between the cervical vertebrae and the thoracic vertebrae.

A massage apparatus according to the present invention for accomplishing the above and other objects includes a base part configured to be supported by the floor and protruding upwards, a pair of main protrusions protruding upwards from respective side portions of the base part, a plurality of sub-protrusions formed between the pair of main protrusions so as to be lower and smaller than the pair of main protrusions, and a lower rounded part formed on the lower surface of the base part so as to be rounded downwards and to take the form of a convex curved surface.

The pair of main protrusions may be inclined relative to each other so as to correspond to orientation angles of a pair of iliopsoas muscles of the human body.

The base part may have a periphery formed in a shape substantially similar to the shape of the pelvis.

The plurality of sub-protrusions may include two middle sub-protrusions and two outer sub-protrusions respectively located to the left and to the right of the two middle sub-protrusions.

The massage apparatus may further include a first depressed portion located in front of the plurality of sub-protrusions and concavely formed to a point higher than the base part and a second depressed portion located behind the plurality of sub-protrusions and formed so as to penetrate the base part.

The massage apparatus may further include a first inclined surface formed on the front of each of the plurality of sub-protrusions and a second inclined surface formed on the back of each of the plurality of sub-protrusions, and the first inclined surface may be steeper than the second inclined surface.

The massage apparatus may further include a pair of protrusion-corresponding recesses formed in the lower surface of the massage apparatus so as to extend upwards at positions corresponding to the pair of main protrusions.

The massage apparatus may be divided into an upper part and a lower part based on a plane passing through the periphery of the base part.

The massage apparatus may further include a concave portion concavely formed in a separation surface of the upper part and a protruding portion protruding from a separation surface of the lower part and inserted into the concave portion.

Each of the concave portion and the protruding portion may be formed to have a circular-shaped section.

Each of the concave portion and the protruding portion may be formed to have an elliptical-shaped section.

The pair of main protrusions may massage the iliopsoas muscles, the waist muscles, or the thigh muscles of the human body.

The plurality of sub-protrusions may massage the muscles between the occipital bone and the cervical vertebrae or the muscles between the cervical vertebrae and the thoracic vertebrae.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a perspective view of a massage apparatus according to an embodiment of the present invention;

FIG. 2 is a top view of the massage apparatus according to the embodiment of the present invention;

FIG. 3 is a front view of the massage apparatus according to the embodiment of the present invention;

FIG. 4 is a rear view of the massage apparatus according to the embodiment of the present invention;

FIG. 5 is a bottom view of the massage apparatus according to the embodiment of the present invention;

FIG. 6 is a side view of the massage apparatus according to the embodiment of the present invention;

FIGS. 7A and 7B are exploded perspective views of a massage apparatus according to another embodiment of the present invention;

FIG. 8 is a perspective view showing a user receiving massage of the iliopsoas muscles using the massage apparatus;

FIG. 9 is a perspective view showing a user receiving massage of the waist muscles using the massage apparatus;

FIG. 10 is a perspective view showing a user receiving massage of the thigh muscles using the massage apparatus; and

FIG. 11 is a perspective view showing a user receiving massage of the muscles of the back of the neck using the massage apparatus.

### DETAILED DESCRIPTION OF THE INVENTION

The present invention will now be described more fully hereinafter with reference to the accompanying drawings, in which various embodiments are shown. The examples, however, may be embodied in many different forms and should not be construed as being limited to the embodiments set forth herein. It is to be understood that the present invention covers all modifications, equivalents, and alternatives falling within the scope and spirit of the present disclosure.

The terminology used herein is for the purpose of describing particular embodiments only and is not intended to be limiting of exemplary embodiments of the invention. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

Hereinafter, exemplary embodiments of the present invention will be described in detail with reference to the accompanying drawings. Wherever possible, the same reference numerals will be used throughout the drawings to refer to the same or like parts. In the following description of the present invention, a detailed description of known functions or known configurations incorporated herein will be omitted when it may make the subject matter of the present invention rather unclear. In the drawings, elements may be exaggerated in size, omitted, or schematically illustrated for convenience in description and clarity.

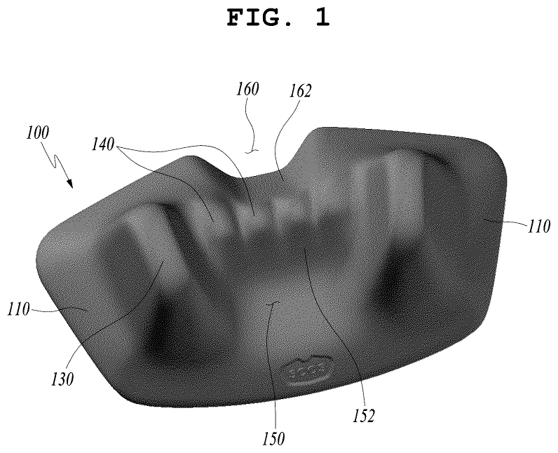

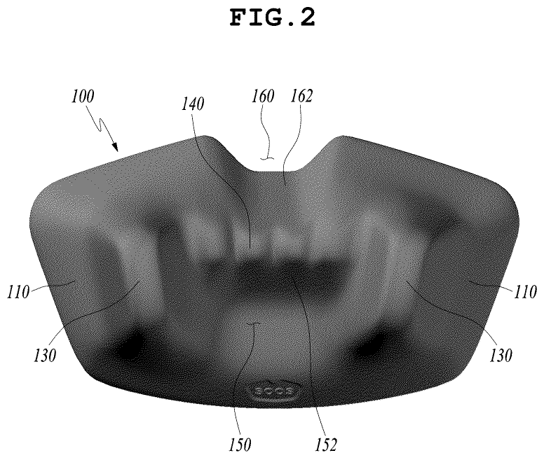

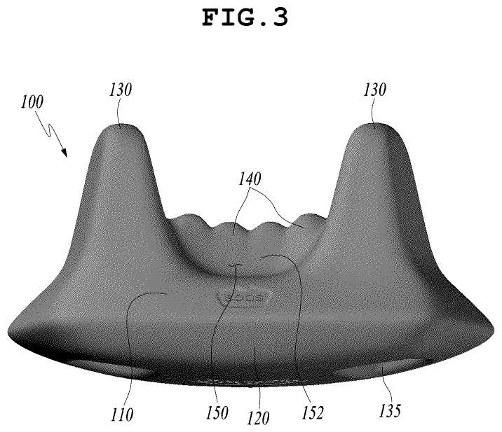

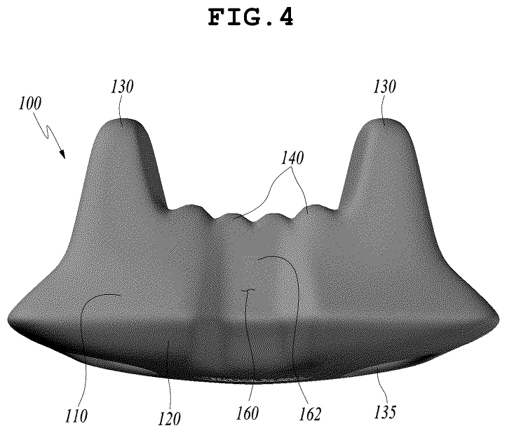

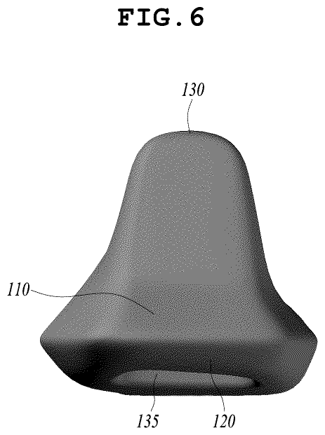

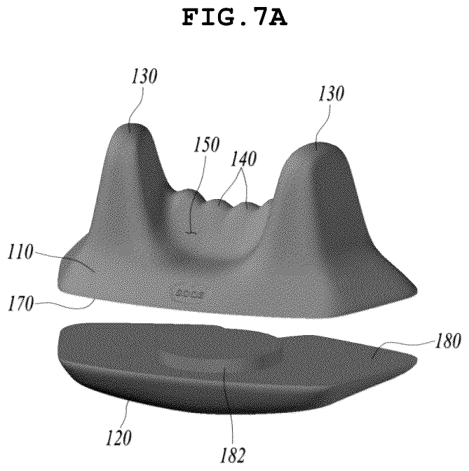

FIGS. 1 to 6 are views showing a massage apparatus according to an embodiment of the present invention, and FIGS. 7A and 7B are exploded perspective views of a massage apparatus according to another embodiment of the present invention.

A massage apparatus 100 according to an embodiment of the present invention includes a base part 110, which is supported by the floor and protrudes upwards, a pair of main protrusions 130, which protrude upwards from respective side portions of the base part, a plurality of sub-protrusions 140, which are formed between the pair of main protrusions so as to be lower and smaller than the main protrusions, and a lower rounded part 120, which is formed on the lower surface of the base part so as to be rounded downwards and thus to take the form of a convex curved surface.

The lower surface of the base part 110 may be substantially flat so as to be supported by the floor. The periphery of the base part 110 may be formed so as to be located in the same plane, and thus may be supported by the floor. The base part 110 may be formed so as to protrude upwards from the periphery thereof.

The pair of main protrusions 130 may protrude to a predetermined height upwards from respective side portions of the base part 110. Each of the main protrusions 130 may be formed such that the length thereof in the forward-backward direction is much greater than the width thereof in the leftward-rightward direction.

The plurality of sub-protrusions 140 may be formed between the pair of main protrusions 130. The sub-protrusions 140 may protrude to a height half the height of the main protrusions 130, and may be disposed adjacent to the rear portions of the main protrusions 130. The number of sub-protrusions 140 may be an even number. The left and right sub-protrusions 140 may be formed to be slightly higher than the middle sub-protrusions 140.

The lower rounded part 120 may be integrally formed with the base part 110. The lower rounded part 120 may protrude from the lower surface of the base part 110 so as to be rounded downwards in the shape of a convex curved surface. Accordingly, the massage apparatus 100 may roll to the left and the right due to the lower rounded part 120 when used. This rolling movement functions to activate the parasympathetic nerve, thereby enabling comfortable relaxation of the muscles.

The pair of main protrusions 130 may be inclined relative to each other so as to correspond to the orientation angles of a pair of iliopsoas muscles of the human body. Each iliopsoas muscle includes an iliacus muscle and a psoas muscle. The psoas muscle is a muscle that connects the lumbar spine to the hip joint and extends obliquely. The pair of main protrusions 130 may be formed to have a predetermined interval therebetween and predetermined inclination angles suitable for massaging the pair of psoas muscles of the human body. Because the iliopsoas muscles are located deep inside the human body, it is difficult for an ordinary person, rather than a professional massage therapist, to accurately massage the iliopsoas muscles. According to the present invention, since the pair of main protrusions 130 are formed to correspond to the pair of iliopsoas muscles, a user may easily and accurately receive massage of the iliopsoas muscles using his/her weight merely by lying with his/her face down on the massage apparatus 100 such that the pair of main protrusions 130 are aligned with the pair of iliopsoas muscles.

The periphery of the base part 110 may be formed in a shape substantially similar to the shape of the pelvis. That is, the periphery of the base part 110 is modeled after the pelvic bones and the muscles around the same.

The plurality of sub-protrusions 140 may include two middle sub-protrusions and two outer sub-protrusions respectively located to the left and to the right of the two middle sub-protrusions. The four sub-protrusions 140 may be formed in a shape in which ridges and valleys are alternately arranged in the leftward-rightward direction. The height of the four sub-protrusions 140 may be approximately half the height of the main protrusions 130. The two outer sub-protrusions 140 may be formed to be slightly higher than the two middle sub-protrusions 140.

When the user receives massage of the suboccipital muscles using the plurality of sub-protrusions 140, the middle sub-protrusions 140 may relax the rectus capitis posterior minor muscle, and the outer sub-protrusions 140 may relax the obliquus capitis superior muscle.

The massage apparatus 100 according to the present invention may further include a first depressed portion 150, which is located in front of the plurality of sub-protrusions 140 and is concavely formed to a point higher than the base part 110, and a second depressed portion 160, which is located behind the plurality of sub-protrusions 140 and is formed so as to penetrate the base part 110.

The first depressed portion 150 may be concavely formed so as to be surrounded by the two main protrusions 130 and the plurality of sub-protrusions 140. The bottom surface of the first depressed portion 150 may have a curved surface portion that is substantially parallel to the base part 110.

The second depressed portion 160 may be formed at a predetermined inclination angle in a manner such that a portion of the periphery of the base part 110, which is located behind the plurality of sub-protrusions 140, is concavely depressed.

The front surface of each of the plurality of sub-protrusions 140 may be formed as a first inclined surface 152, and the rear surface thereof may be formed as a second inclined surface 162. The first inclined surface 152 may be formed to be steeper than the second inclined surface 162. The inclination of the first inclined surface 152 relative to the horizontal plane may gradually decrease from the upper portion thereof, which is adjacent to the upper end of each of the plurality of sub-protrusions 140, to the lower portion thereof, which is adjacent to the first depressed portion 150.

When the user lies on the massage apparatus 100 to receive massage of the muscles of the back of the neck, the first inclined surface 152 and the first depressed portion 150 may function to guide the lower cervical vertebra to be located at the neutral position. In addition, when the user receives massage of the muscles around the upper cervical vertebra, the second inclined surface 162 and the second depressed portion 160 may function to guide the head to be naturally tilted back and located at the neutral position.

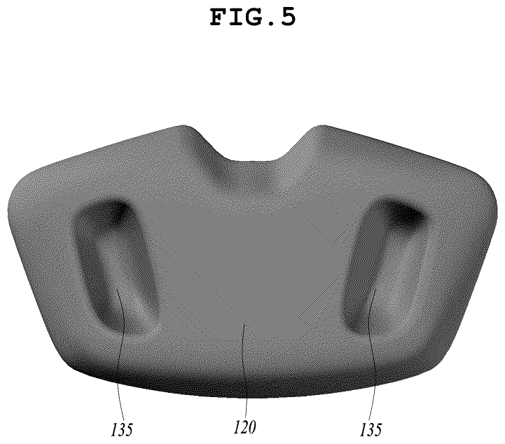

As shown in FIG. 5, the massage apparatus 100 may further include a pair of protrusion-corresponding recesses 135, which are formed in the lower surface thereof so as to extend upwards at positions corresponding to the pair of main protrusions 130.

The massage apparatus 100 may be made of a polyurethane foam or an integral skin foam, and may have an integrated form.

Each of the pair of main protrusions 130 may be formed to a predetermined thickness due to a respective one of the pair of protrusion-corresponding recesses 135. The main protrusion 130 may be formed such that the thickness thereof gradually increases from the upper portion thereof to the lower portion thereof. By virtue of the pair of protrusion-corresponding recesses 135, the massage apparatus 100 according to the present invention may exhibit sufficient solidity and simultaneously reduce material consumption.

As shown in FIGS. 7A and 7B, the massage apparatus 100 may be divided into an upper part and a lower part based on a plane passing through the periphery of the base part 110. When the massage apparatus 100 is divided into the upper and lower parts, a lower separation surface 180, which is the upper surface of the lower part, may be separated from an upper separation surface 170, which is the lower surface of the upper part. When the user does not need to roll the massage apparatus 100 to the left or the right, the user may separate the upper part from the lower part, and then may place the upper part on the floor. In this case, the upper separation surface 170, which is flat, is placed on the floor, and thus the user may receive massage in the state in which the upper part is stably supported by the floor.

The massage apparatus 100 may further include a concave portion 172, which is concavely formed in the upper separation surface 170, and a protruding portion 182, which protrudes from the lower separation surface 180 and is inserted into the concave portion 172.

The concave portion 172 may be formed to a predetermined depth in the substantially central portion of the upper separation surface 170. The protruding portion 182 may be formed on the substantially central portion of the lower separation surface 180 so as to have a shape corresponding to the shape of the concave portion 172.

As shown in FIG. 7B, each of the concave portion 172 and the protruding portion 182 may be formed to have a circular-shaped section. That is, the concave portion 172 and the protruding portion 182 may be formed in the same shape as each other, i.e. a circular disc shape. The protruding portion 182 may be coupled to the concave portion 172 in an interference-fit manner. However, each of the upper part and the lower part of the massage apparatus 100 is made of a slightly elastic material and has an integrated form, and thus the protruding portion 182 may be easily coupled to and separated from the concave portion 172.

Alternatively, each of the concave portion 172 and the protruding portion 182 may be formed to have an elliptical-shaped section. Each of the concave portion 172 and the protruding portion 182 may be formed such that the long axis of the elliptical-shaped section thereof is oriented in the leftward-rightward direction. Accordingly, when the concave portion 172 and the protruding portion 182, each of which has an elliptical-shaped section, are coupled to each other, the upper part and the lower part of the massage apparatus 100 may be coupled to each other in the state in which the angular positions thereof are naturally aligned with each other.

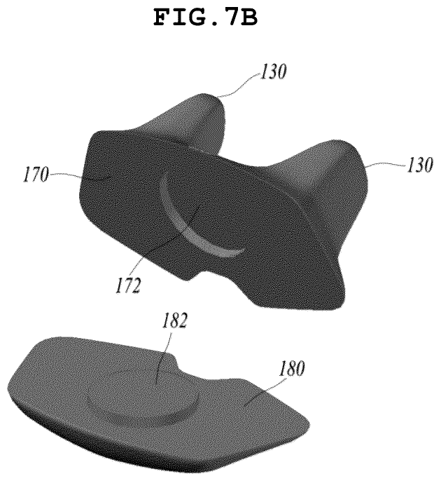

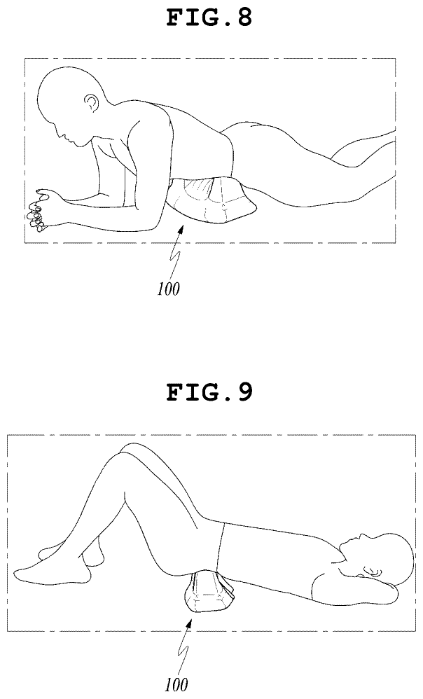

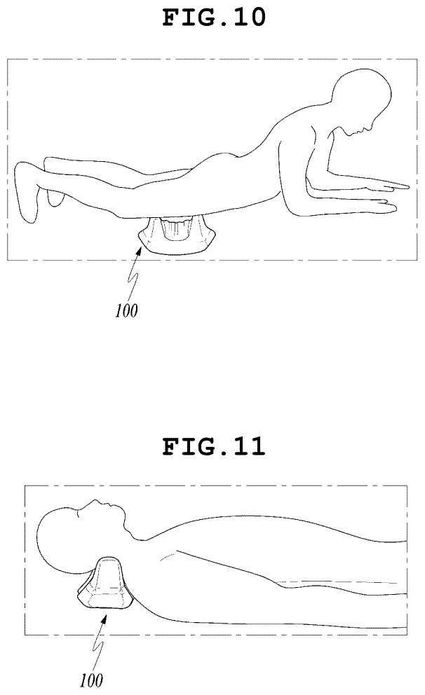

FIG. 8 is a perspective view showing the user receiving massage of the iliopsoas muscles using the massage apparatus, FIG. 9 is a perspective view showing the user receiving massage of the waist muscles using the massage apparatus, FIG. 10 is a perspective view showing the user receiving massage of the thigh muscles using the massage apparatus, and FIG. 11 is a perspective view showing the user receiving massage of the muscles of the back of the neck using the massage apparatus.

The pair of main protrusions 130 may massage the iliopsoas muscles, the waist muscles, or the thigh muscles of the human body.

As shown in FIG. 8, the user may receive massage of the iliopsoas muscles by applying his/her weight to the massage apparatus 100 in the state of placing the parts of his/her stomach that correspond to the pair of iliopsoas muscles on the pair of main protrusions 130. In this case, the user may receive massage by placing his/her knees and elbows on the floor and pressing the parts of his/her stomach that correspond to the iliopsoas muscles against the massage apparatus 100 with varying force. In addition, the user may efficiently receive massage of the pair of left and right iliopsoas muscles by rolling the massage apparatus 100 to the left and the right.

As shown in FIG. 9, the user may receive massage of the waist muscles or the hip muscles using the massage apparatus 100 by placing the same on the pair of main protrusions 130. In the case, the user may adjust the force with which the user presses the waist muscles or the hip muscles against the massage apparatus 100, i.e. the intensity of the massage, by placing his/her back and the soles of his/her feet on the floor and bending his/her knees.

As shown in FIG. 10, the user may receive massage of the thigh muscles using the massage apparatus 100 by placing the same on the pair of main protrusions 130. Further, the user may receive massage of the muscles of the front, back, or side of the thigh or the calf muscles by placing the same on the pair of main protrusions 130.

As shown in FIG. 11, the user may receive massage of the muscles between the occipital bone and the cervical vertebrae or the muscles between the cervical vertebrae and the thoracic vertebrae using the plurality of sub-protrusions 140.

When the user lies in the state in which his/her neck is placed on the plurality of sub-protrusions 140 of the massage apparatus 100 such that the first depressed portion 150 is oriented toward his/her legs, the user may receive massage of the muscles between the occipital bone and the cervical vertebrae. That is, the middle sub-protrusions 140 may relax the rectus capitis posterior minor muscle, among the suboccipital muscles, and the outer sub-protrusions 140 may relax the obliquus capitis superior muscle, among the suboccipital muscles.

When the user lies in the state in which his/her neck is placed on the plurality of sub-protrusions 140 of the massage apparatus 100 such that the first depressed portion 150 is oriented toward his/her head, the user may receive massage of the muscles between the cervical vertebrae and the thoracic vertebrae. That is, the plurality of sub-protrusions 140 may selectively massage the first cervical vertebra to the seventh cervical vertebra depending on the part of the neck that is placed thereon, and may mainly relax the muscles around the lower cervical vertebra. For example, the plurality of sub-protrusions 140 may massage the splenius capitis muscle, the semispinalis capitis muscle, the levator scapulae muscle, and the like.

As is apparent from the above description, the massage apparatus according to the present invention may massage the iliopsoas muscles, the waist muscles, or the thigh muscles located deep inside the human body and may massage the muscles between the occipital bone and the cervical vertebrae or the muscles between the cervical vertebrae and the thoracic vertebrae.

Although specific embodiments of the present invention have been disclosed for illustrative purposes, those skilled in the art will appreciate that various modifications, additions, and substitutions are possible, without departing from the scope and spirit of the invention as disclosed in the accompanying claims. Further, such modifications, additions, and substitutions of the present invention are to be appreciated as being included in the scope and spirit of the invention.

What is claimed is:

1. A massage apparatus comprising:
a base part configured to be supported by a floor and protruding upwards;
a pair of main protrusions protruding upwards from respective side portions of the base part;
a plurality of sub-protrusions formed between the pair of main protrusions so as to be lower and smaller than the pair of main protrusions; and
a lower rounded part formed on a lower surface of the base part so as to be rounded downwards and to take a form of a convex curved surface.

2. The massage apparatus according to claim 1, wherein the pair of main protrusions are inclined relative to each other so as to correspond to orientation angles of a pair of iliopsoas muscles of a human body.

3. The massage apparatus according to claim 1, wherein the base part has a periphery formed in a shape substantially similar to a shape of a pelvis.

4. The massage apparatus according to claim 1, wherein the plurality of sub-protrusions comprise two middle sub-protrusions and two outer sub-protrusions respectively located to a left and to a right of the two middle sub-protrusions.

5. The massage apparatus according to claim 4, further comprising:
a first depressed portion located in front of the plurality of sub-protrusions and concavely formed to a point higher than the base part; and
a second depressed portion located behind the plurality of sub-protrusions and formed so as to penetrate the base part.

6. The massage apparatus according to claim 5, further comprising:
a first inclined surface formed on a front of each of the plurality of sub-protrusions; and
a second inclined surface formed on a back of each of the plurality of sub-protrusions,
wherein the first inclined surface is steeper than the second inclined surface.

7. The massage apparatus according to claim 1, further comprising:
a pair of protrusion-corresponding recesses formed in a lower surface of the massage apparatus so as to extend upwards at positions corresponding to the pair of main protrusions.

8. The massage apparatus according to claim 1, wherein the massage apparatus is divided into an upper part and a lower part based on a plane passing through a periphery of the base part.

9. The massage apparatus according to claim 8, further comprising:
a concave portion concavely formed in a separation surface of the upper part; and
a protruding portion protruding from a separation surface of the lower part and inserted into the concave portion.

10. The massage apparatus according to claim 9, wherein each of the concave portion and the protruding portion is formed to have a circular-shaped section.

11. The massage apparatus according to claim 9, wherein each of the concave portion and the protruding portion is formed to have an elliptical-shaped section.

12. The massage apparatus according to claim 1, wherein the pair of main protrusions massage iliopsoas muscles, waist muscles, or thigh muscles of a human body.

13. The massage apparatus according to claim 1, wherein the plurality of sub-protrusions massage muscles between an occipital bone and cervical vertebrae or muscles between the cervical vertebrae and thoracic vertebrae.
